(19) United States
(12) Patent Application Publication
(10) Pub. No.: US 2025/0319334 A1
(43) Pub. Date: Oct. 16, 2025

(54) ROPING HARNESS

(71) Applicant: ZEDEL, Crolles (FR)

(72) Inventor: Simon EMONIN, Grenoble (FR)

(73) Assignee: ZEDEL, Crolles (FR)

(21) Appl. No.: 19/174,054

(22) Filed: Apr. 9, 2025

(30) Foreign Application Priority Data
Apr. 10, 2024 (FR) 2403692

(51) Int. Cl. A62B 35/00; A62B 35/04

(52) U.S. Cl. CPC A62B 35/0012; A62B 35/04; A62B 35/0031

(57) ABSTRACT

A roping harness includes a belt, a pair of leg loops and an elastic wire element. The belt has a lining arranged between an outer wall and an inner wall. The elastic wire element is securedly attached to the belt and has one end arranged movably with respect to the belt by elastic deformation. The lining defines a channel receiving a part of the elastic wire element. The outer wall defines a right through hole or a left through hole opening out facing the channel. The elastic wire element passes through the two through holes so that the end of the elastic wire element is located outside the channel.

### BACKGROUND OF THE INVENTION

The invention relates to a roping harness.

### PRIOR ART

When performing acrobatic activities, the user moves vertically along a rope. Downward movement is achieved easily by letting gravity act and adjusting the sliding speed. Ascending on the rope is on the other hand a more energy-consuming operation. To avoid the user tiring himself prematurely by ascending along the rope, it is sought to improve the efficiency of the sliding operation upwards along the rope followed by clamping on the rope.

To improve the efficiency of the rope ascending operation on a single rope, it is particularly advantageous to use a rope clamp for each of the user's feet. One of the rope clamps, for example the right clamp, is fixed directly on one of the user's feet, whereas the other rope clamp (the left clamp) is connected to the other foot by a strap so that the rope clamps do not interfere with one another. To move the left clamp upwards, it is known to connect this clamp to an upper part of the body by means of a flexible strap in order to mechanically bias the left clamp upwards when the left foot is not placing any force on the left clamp. This solution gives good results but it results in having to deal with a bulky rope ascension system when the user reaches his work position and has to move to perform his work.

In an alternative, a rigid mechanical connection exists between the two foot clamps that are connected to the right and left feet in the same way as in the foregoing. The assembly formed by the right foot and left foot is connected to the upper part of the body by means of a flexible element. For example, the flexible element is fixed to the shoulders or to the body clamp. There again, it can be ascertained that the bulk of the rope ascension system is considerable when the latter is not used and has to be stowed on the roping harness.

It is also known to replace a foot clamp by a knee clamp presenting an identical operation, i.e. a clamp that is located at the level of the knee and that is connected to the foot.

To make the elastic wire element that is connected to the rope clamp easy to handle, it is known to modify a harness belt to attach a sheath to the latter at the top of the belt and to install the elastic wire element in the sheath. However, this construction gives rise to other problems in use, with faster wear of the belt.

### OBJECT OF THE INVENTION

One object of the invention consists in providing a roping harness that is easier and more user-friendly to use when performing rope ascension operations and descending operations along the rope, and in which management of the rope ascension system is better integrated.

This result tends to be achieved by means of a roping harness comprising:
a belt with a lining arranged between an outer wall and an inner wall,
a pair of leg loops;
at least one elastic wire element fixedly attached to the belt, the at least one elastic wire element having one end installed movably with respect to the belt by elastic deformation of the elastic wire element, the end having a connector.

The roping harness is remarkable in that:
the lining defines at least one channel receiving a part of the at least one elastic wire element;
the outer wall defines at least a right through hole or a left through hole opening out in the lining, the elastic wire element passing through the at least a right through hole or left through hole so that the end of the at least one elastic wire element is located outside the at least one channel;
the at least one channel has a first thickness;
the at least one elastic wire element has a second thickness smaller than or equal to the first thickness.

According to a preferential feature of the invention, the outer wall defines a right through hole and a left through hole. The at least one channel is a channel extending continuously from the right through hole to the left through hole.

In advantageous manner, the at least one elastic wire element is an elastic wire element extending continuously to pass through the right through hole and the left through hole, each end of the elastic wire element being terminated by a connector.

Preferentially, the elastic wire element is continuously sliding and stretchable between the right through hole and the left through hole.

In a particular configuration, at least one sheath is arranged in the at least one channel, the at least one channel receiving the at least one elastic wire element. The at least one sheath has a third thickness smaller than the second thickness.

In an advantageous development, the outer wall has a greater rigidity than a rigidity of the lining in a longitudinal direction and/or a transverse direction that are perpendicular to a thickness direction.

Preferentially, the at least one sheath is fixed to the outer wall.

According to one embodiment, the sheath is separated from the inner wall by a portion of lining.

In an advantageous development, in a rest position, each end of the at least one elastic wire element is pressing against an apertured plate attached to the outer wall.

In another advantageous development, the at least one end is fixed to a rope clamp designed to form a right foot clamp or a left foot clamp.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a perspective view of a roping harness equipped with an elastic wire element exiting via a through hole of the belt to connect a rope clamp;

FIG. 2 schematically illustrates views of the inner face and the outer face of the internal lining of a roping harness belt;

FIG. 3 schematically illustrates different steps of manufacture of a roping harness belt;

FIG. 4 schematically illustrates a sectional view of a roping harness belt provided with a sheath inside a lining.

### DESCRIPTION OF THE EMBODIMENTS

FIG. 1 illustrates an embodiment of a roping harness 1 that is equipped with a belt 2, a pair of leg loops 3 and an elastic wire element 4 one end whereof is arranged movable with respect to the belt 2 to move towards or away from a foot of a user wearing the roping harness 1.

The belt 2 has an inner wall 2a, a lining 2b and an outer wall 2c. The inner wall 2a, the lining 2b and the outer wall 2c are arranged successively in a thickness direction. The inner wall 2a is designed to come into contact with the user and the lining 2b is separated from the user by the inner wall 2a. In a particular embodiment, the inner wall 2a and the outer wall 2c join one another on their peripheral parts to form an enclosure housing the lining 2b.

The outer wall 2c defines at least one through hole that is a right through hole 5a or a left through hole 5b. The outer wall 2c preferably defines a right through hole 5a and a left through hole 5b. The right through hole 5a and the left through hole 5b are separated by the median sagittal plane of the user who is wearing the roping harness 1. The right through hole 5a is preferably arranged facing the right iliac fossa whereas the left through hole 5b is arranged facing the left iliac fossa when the roping harness 1 is worn by a user in a standing position. The facing is observed in a direction perpendicular to the median sagittal plane.

The lining 2b defines at least one channel 6 designed to receive a part of the elastic wire element 4. A part of the elastic wire element 4 is arranged in the channel 6. The through hole 5 is arranged facing the channel 6 to allow the elastic wire element 4 to pass the through hole 5 and to allow one end of the elastic wire element 4 to move with respect to the belt 2 by elastic deformation of the elastic wire element 4.

The elastic wire element 4 is an elastic wire element that is deformable independently of the belt 2, enabling the elastic wire element 4 to have an end that moves away from the belt 2, for example to reach a knee or foot of the user wearing the rope harness 1. The end of the elastic wire element 4 can move away from the belt by pulling on the elastic wire element 4 to extend the elastic wire element 4. The end of the elastic thread element 4 can be pulled away from the belt by pulling on the elastic thread element 4 to lengthen the elastic wire element 4. Once the effort is stopped, or by reducing the effort applied, the elastic wire element 4 shortens, bringing the end of the elastic wire element 4 and the belt 2 closer together.

In one embodiment, the outer wall 2c defines a right through hole 5a and a left through hole 5b. This configuration enables a roping harness 1 to be had that is suitable for a user whose rope clamp 7 connected to a foot or a knee by a strap or a rope is the right or left foot/knee.

The roping harness 1 can have a single elastic wire element 4 that opens onto the outer wall 2c via each of the two through holes 5. As an alternative, the roping harness 1 has a right elastic wire element and a left elastic wire element. Preferentially, the lining 2b defines a single channel 6 that extends from the right through hole 5a to the through hole left 5b. A lining 2b defining a right channel and a left channel is also possible.

The roping harness 1 has at least one elastic wire element 4 that is arranged in the at least one channel 6 between the inner wall 2a and the outer wall 2c. The at least one elastic wire element 4 passes through the outer wall 2c via the through hole 5 so as to be able to extend as far as a knee or a foot. In addition, it is particularly advantageous for the end of the elastic wire element 4 in its rest position, i.e. without any external stress, to be pressing against the part of the belt 2 defining the through hole 5, i.e. for a very large majority of the elastic wire element 4 to be stowed in the belt 2.

The distance between the iliac fossa and the knee or between the iliac fossa and the foot is relatively large compared with the length of the dorsal part of the belt 2 designed to store the elastic wire element 4. It is therefore advantageous to have an elastic wire element 4 that is as long as possible to limit the elongation of the elastic wire element 4 and to thus have an elastic force that is more suitable for raising the rope clamp 7 if no load is present.

It is particularly advantageous to have an elastic wire element 4 that extends continuously from the right through hole 5a to the left through hole 5b and that is continuously sliding between the right through hole 5a and the left through hole 5b. In addition to being suitable for a user whose support foot is a right foot or a left foot, the elastic wire element 4 has a length that is substantially equal to the distance separating the right through hole 5a and the left through hole 5b, and the whole of this length of the elastic wire element 4 is used. The elastic wire element 4 is installed sliding continuously with respect to the lining 2b between the right through hole 5a and the left through hole 5b. The two ends of the elastic wire element 4 can move independently of each other.

Installing the elastic wire element 4 inside the belt 2 between the inner wall 2a and the outer wall 2c enables the inside of the belt 2 to be functionalised. The elastic wire element 4 no longer needs to be removed and then attached after use, it is stowed automatically in the belt 2.

Installing the channel 6 inside the belt 2 instead of at the top of the belt 2 improves the mechanical connection between the belt 2 and the elastic wire element 4. The forces applied downwards when the end of the elastic wire element 4 is stressed are better absorbed by the outer wall 2c.

It is particularly advantageous to attach the elastic wire element 4 to a resilient element 8 that provides the mechanical resistance of the roping harness 1 in case of a fall.

In preferential manner, the belt 2 defines a sheath 9 and the elastic wire element 4 is arranged inside the sheath 9. It is particularly advantageous for the belt 2 to be provided with a right through hole 5a and a left through hole 5b and for the sheath 9 to define a path for the elastic wire element 4 to pass between the right through hole 5a and the left through hole 5b. For example, the sheath 9 extends continuously from the right through hole 5a to the left through hole 5b. The elastic wire element 4 can slide freely along the sheath 9. It is also possible for the sheath 9 to be formed by several individual sheaths arranged at a distance from one another to define the path.

When the path is a straight line between the right through hole 5a and the left through hole 5b, it is advantageous to secure individual sheaths to the inner wall 2a. The forces in the longitudinal direction are absorbed by the outer wall 2c and or the resilient element 8.

It is also possible for the sheath 9 to be attached to the outer wall 2c that is chosen to present an increased rigidity compared with the lining 2b in order to withstand the stresses on the elastic wire element 4. Stressing of the rope clamp 7 attached to the end of the elastic wire element 4 results in stressing of the outer wall 2c or of the resilient element 8. It is advantageous to mechanically dissociate the lining 2b and the sheath 9 to avoid deforming the lining 2b and creating a discomfort zone in the user's back.

The lining 2b defines at least one channel 6 that presents a first thickness. The first thickness is greater than a second thickness that is the thickness of the elastic wire element 4 thereby avoiding having a bulge associated with the elastic wire element 4 compared with the outer surface of the outer wall 2c and compared with the inner surface of the inner wall 2a. The presence of a bulge on the surface of the inner wall 2a introduces a discomfort zone. The presence of a bulge on the outer wall 2c introduces a zone which wears more quickly.

When the belt 2 is provided with a sheath 9 receiving the elastic wire element 4, the sheath 9 has a third thickness. The third thickness is greater than the first thickness and smaller than the second thickness in order not to form a bulge associated with the assembly formed by the sheath 9 and the elastic wire element 4 compared with the outer surface of the outer wall 2c and compared with the inner surface of the inner wall 2a.

The at least one elastic wire element 4 extends beyond the outer wall 2c in the direction of a leg loop 3 and towards a foot or a knee. The right part of the at least one elastic wire element 4 passes through the right through hole 5a and can support a connector 10 forming a right connector. The left part of the at least one elastic wire element 4 passes through the left through hole 5b and can support a connector 10 forming a left connector. The elastic wire element 4 presents an inflection on exit from the channel 6 in the direction of a knee or a foot. In preferential manner, the belt 2 comprises a right plate and/or a left plate defining a through aperture that opens out facing the right through hole 5a and the left through hole 5b. The plate 11 is salient from the outer wall 2c. The plate 11 defines an outlet the exit direction of which is directed downwards. The exit direction is arranged in the angular range comprised between the mean longitudinal direction of the elastic wire element 4 between the right through hole 5a and the left through hole 5b and the longitudinal direction of a leg of a user wearing the roping harness 1 in the standing position with both feet on the ground.

The plate 11 enables an inflection of the elastic wire element 4 to be introduced so as to reduce the friction to facilitate transmission of forces and limit the wear of the elastic wire element 4. The plate 11 defines a sliding area for the elastic wire element 4.

The plate 11 performs protection of the elastic wire element immediately on exit from the outer wall 2c.

In preferential manner, the end of the elastic wire element 4 has a connector 10 that is for example a knot or any other attachment means. The connector 10 prevents the end of the elastic wire element 4 from passing the through hole 5 and possibly through the plate 11. The connector 10 at the end of the elastic wire element 4 can also be a carabiner, a shackle, a quick link or any other device able to receive a rope clamp 7. An additional connector 12 can be used to connect the connector 10 and the rope clamp 7.

During use, the connector 10 can be attached directly or indirectly to a rope clamp 7 that is attached to a foot or a knee. During the ascension phases on the rope, the foot or knee moves towards and then away from the belt 2. The rope clamp 7 performs a back-and-forth movement with respect to the belt 2. The elastic wire element 4 expands and contracts alternately to follow the extensions of its attachment leg. The elastic wire element 4 enters and then exits the channel 6. When the user's leg stresses the rope clamp 7 downwards, the leg applies a force on the elastic wire element 4 that deforms the latter elastically in extension. A part of the elastic wire element 4 leaves the channel 6. When the leg reduces the force applied on the elastic wire element 4, the elastic wire element 4 contracts and at least partially enters the channel 6.

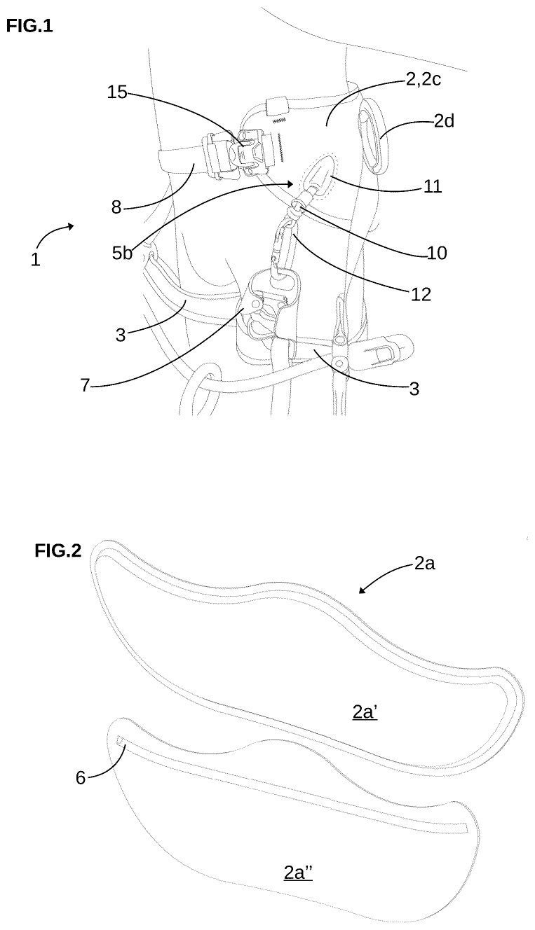

In a preferential embodiment illustrated in FIG. 2, the lining 2b and the inner wall 2a are formed by the same part. The lining 2b defines a groove that forms a channel 6. The groove does not pass through the element forming the inner wall 2a and the lining 2b in the thickness direction in order to define an inner wall 2a blocking the elastic wire element 4 in the belt 2. The outer face 2a′ is illustrated by the top image whereas the inner face 2a″ is illustrated by the bottom image.

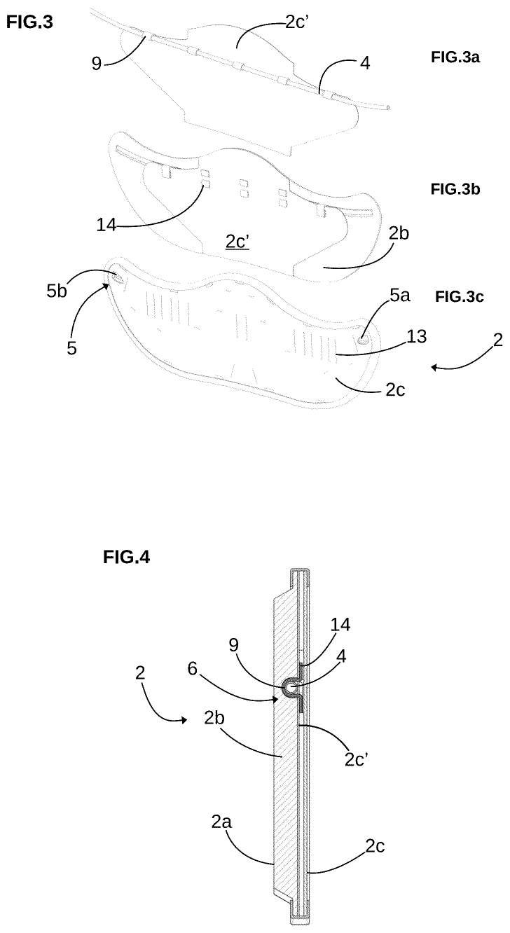

FIG. 3 illustrates the steps of manufacture of a belt 2 of a roping harness 1. FIG. 3a illustrates a reinforcement part 2c′ that supports individual sheaths 9 and an elastic wire element 4. FIG. 3b illustrates installation of the reinforcement part 2c′ and of the elastic wire element 4 with the lining 2b. FIG. 3c illustrates installation of the outer wall 2c on the lining 2b associated with the reinforcement part 2c′.

In the illustrated embodiment, the reinforcement part 2c′ defines the position of the multiple individual sheaths 9 receiving the elastic wire element 4. The lining 2b defines a channel 6 and the elastic wire element 4 already shaped by means of the individual sheaths 9 fixed to the reinforcement part 2c′ is installed in the channel by installing the reinforcement part 2c′. The outer wall 2c is installed on the reinforcement part 2c′ and on the lining 2b to block the reinforcement part 2c′ between the inner wall 2a and the outer wall 2c.

In preferential manner, the outer wall 2c defines slits 13 for the resilient element 8 to pass. The outer wall 2c defines a right through hole 5a and a left through hole 5b the shapes of which are arranged to receive the plates 11.

The elastic wire element 4 can be formed by an element that is homogeneous from one end to the other advantageously with an elongation ratio of more than 50%, for example by a rope or a strap that is elastically deformable. As an alternative, the elastic wire element 4 is formed in several parts having elongation at break values that are different. The end can be formed by an element having a lower elongation at break value than the part designed to be located in the channel 6.

As illustrated in FIG. 1, it is advantageous for the resilient element 8 to be in the form of a strap terminated by an opening-closing device 15 configured to define an open position and a closed position. In the open position, the user can don or doff the roping harness 1. In the closed position, the user and the roping harness 1 are inseparable.

Belt 2 can have one or more anchor points 2d that are attached to the resilient element 8 to ensure suspension of the user installed in the roping harness 1.

In the embodiment illustrated in FIG. 3, the reinforcement part 2c′ is equipped with spacers 14 separating the lining 2b and the outer wall 2c.

In the embodiment shown in FIG. 3, the reinforcement part 2c′ is provided with spacers 14 to space the lining 2b and the outer wall 2c.

The elastic wire element 4 is not a safety element intended to provide mechanical resistance to the belt 2 when the user is suspended in the roping harness 1. The elastic wire element 4 is distinct from the resilient element 8. The elastic wire element 4 is not intended to tighten the belt 2, nor to act on the circumference of the belt 2. The elastic thread element 4 is not attached to a belt circumference adjuster, nor is it attached to opening/closing device 15 configured to open or close the belt. The elastic wire element 4 deforms independently from the resilient element 8 to allow the connector 10 to move relative to the belt 2, regardless of whether the user is suspended in the rope harness or not.

As illustrated, it is advantageous that the elastic wire element 4 does not form a complete turn of the belt 2. As illustrated, the elastic thread element 4 extends over part of the length of the belt 2 and preferably the elastic wire element 4 extends over the rear part of the belt 2 and advantageously up to the right and left front edges which lie in the front half of the roping harness when worn. When the user is suspended in the rope harness, the elastic wire element 4 is unable to adjust the length of the belt 2.

The elastic wire element 4 is elastically deformable relative to the belt 2. Extending and shortening the elastic wire element 4 does not alter the circumference of the belt 2.

The elastic wire element 4 is elastically deformable when the belt 2 is closed and when the belt 2 is open. Preferably, the elastic wire element 4 has a maximum length which is greater than the length of the belt 2.

As shown in FIG. 1, in a rest position, the end of the elastic wire element 4 rests against the edge of the through-hole. The elasticity of the elastic wire element 4 generates a restoring force that places the end of the elastic wire element 4 against the edge of the through-hole. Preferably, the elasticity of the elastic wire element 4 generates a restoring force sufficient to place the end of the elastic wire element 4 against the edge of the through-hole when a rope clamp 7 is hooked to the end of the elastic wire element 4.

As illustrated in FIG. 1, it is advantageous that one end of the channel 6 near the through hole 5 is directed downwards so that the end of the elastic wire element 4 is directed downwards, which facilitates deformation of the elastic wire element 4 when the rope clamp 7 moves up and down following a knee or foot in leg extension and leg bending phases. This reduces friction and facilitates deformation of the elastic wire element 4 for a given effort.

1. A roping harness comprising:
a belt with a lining arranged between an outer wall and an inner wall, the lining defining at least one channel between the inner wall and the outer wall, the outer wall defining at least one right through hole or one left through hole opening out in the lining to face the channel, the at least one channel having a first thickness;
a pair of leg loops;
a resilient element attached to the belt and providing mechanical resistance in case of a fall
an elastic wire element different from the resilient element;
fixedly attached to the belt, the at least one elastic wire element having one end installed movably with respect to the belt by elastic deformation of the elastic wire element, the end having a connector;
wherein the elastic wire element is disposed in the channel and passes through at least one of the right through hole and the left through hole so that one end of the elastic wire element opens out of the at least one channel, the end having a connector arranged outside the channel;
wherein the connector is mounted so as to be movable relative to the belt in order to move away from or towards the belt by elastic lengthening or shortening of the elastic wire element;
wherein the elastic wire element generates a restoring force which places the end of the elastic wire element against an edge of the right through-hole or of the left through-hole, in a rest position;
wherein the end of the elastic wire element is able to move up to a knee or a foot when the roping harness is worn; and
wherein the at least one elastic thread element has a second thickness less than or equal to the first thickness.

2. The roping harness according to claim 1 wherein the outer wall defines one right through hole and one left through hole and wherein the at least one channel is a channel extending continuously from the right through hole to the left through hole.

3. The roping harness according to claim 2 wherein the at least one elastic wire element is an elastic wire element extending continuously to pass through the right through hole and the left through hole, each end of the elastic wire element being terminated by a connector.

4. The roping harness according to claim 3 wherein the elastic wire element is continuously sliding and stretchable between the right through hole and the left through hole.

5. The roping harness according to claim 1 wherein at least one sheath is arranged in the at least one channel, the at least one channel receiving the at least one elastic wire element, and wherein the at least one sheath has a third thickness smaller than the second thickness.

6. The roping harness according to claim 1 wherein the outer wall has a greater elasticity modulus than an elasticity modulus of the lining in a transverse direction.

7. The roping harness according to claim 6 wherein the outer wall has a greater elasticity modulus than an elasticity modulus of the lining in a longitudinal direction that are perpendicular to a thickness direction.

8. The roping harness according to claim 6 wherein at least one sheath is arranged in the at least one channel, the at least one channel receiving the at least one elastic wire element, wherein the at least one sheath has a third thickness smaller than the second thickness and wherein the at least one sheath is fixed to the outer wall.

9. The roping harness according to claim 7 wherein the sheath is separated from the inner wall by a portion of lining.

10. The roping harness according to claim 1 wherein, in a rest position, each end of the at least one elastic wire element is pressing against an apertured plate attached to the outer wall.

11. The roping harness according to claim 1 wherein the at least one end is fixed to a rope clamp designed to form a right foot clamp or a left foot clamp.

12. The roping harness according to claim 1 wherein the at least one wire element has an elongation ratio greater than 50%.

13. The roping harness according to claim 2 wherein at least one sheath is arranged in the at least one channel, the at least one channel receiving the at least one elastic wire element, and wherein the at least one sheath has a third thickness smaller than the second thickness.
